(19) United States
(12) Patent Application Publication
(10) Pub. No.: US 2024/0037613 A1
(43) Pub. Date: Feb. 1, 2024

(54) RATING SYSTEM AND METHOD

(71) Applicant: Mark Edward Roberts, Los Angeles, CA (US)

(72) Inventor: Mark Edward Roberts, Los Angeles, CA (US)

(21) Appl. No.: 18/483,507

(22) Filed: Oct. 9, 2023

Related U.S. Application Data
(63) Continuation-in-part of application No. 15/111,749, filed on Jul. 14, 2016, now abandoned.
(60) Provisional application No. 62/025,980, filed on Jul. 17, 2014.

(51) Int. Cl. G06Q 30/0282; G06Q 30/0273; G06Q 30/0251

(52) U.S. Cl. CPC G06Q 30/0282; G06Q 30/0275; G06Q 30/0254

(57) ABSTRACT

A system includes a memory comprising a first preference profile and a second preference profile, a correlation module configured to determine a correlation value between the first preference profile and the second preference profile, and a module configured to take an action as a function of the correlation value. The action is changing a physical configuration of signage from a first physical configuration to a second physical configuration.

### TECHNICAL FIELD

The present application relates to systems and methods for generating and providing user submitted reviews and/or recommendations.

### BACKGROUND

Some review and/or recommendation systems allow users to provide reviews of merchants, goods, service providers, entertainment venues, and the like. In some cases, the systems allow a user to assign a rating value to merchants, goods, service providers, entertainment venues, and the like. In some cases, the systems present the reviews and/or recommendations generated by a first user to a second user so that the second user can attempt to make informed decisions when evaluating and/or selecting merchants, goods, service providers, entertainment venues, and the like. However, in many cases, the personal preferences of the first user are different from the personal preferences of the second user, thereby potentially devaluing and/or negating any benefit the second user may seek from considering the reviews and/or recommendations of the first user.

### BRIEF DESCRIPTION OF THE DRAWINGS

For a more complete understanding of this disclosure, reference is now made to the following description, taken in conjunction with the accompanying drawings, in which:

FIG. 1 is a schematic view of a rating and recommendation system (RRS) in a networked environment according to the present application.

FIG. 2 is a schematic view of the RRS of FIG. 1.

FIG. 3 is a simplified representation of a general-purpose processor (e.g. electronic controller or computer) system suitable for implementing the embodiments of the disclosure.

FIG. 4 is a flowchart showing a method of operating a profile module of the RRS of FIG. 1.

FIG. 5 is a flowchart showing a method of operating a correlation module of the RRS of FIG. 1.

FIG. 6 is a flowchart showing a method of operating a sorting and display module of the RRS of FIG. 1.

FIG. 7 is a flowchart showing a method of operating a recalculation module of the RRS of FIG. 1.

FIG. 8 is a flowchart showing a method of operating a social connection module of the RRS of FIG. 1.

FIG. 9 is a flowchart showing a method of operating a group consensus module of the RRS of FIG. 1.

FIG. 10 is a flowchart showing a method of operating a group forming module of the RRS of FIG. 1.

FIG. 11 is a flowchart showing a method of operating the RRS of FIG. 1 to utilize information from a traditional rating and recommendation system (TRRS).

FIGS. 12-27 are illustrations of example user interfaces of the RRS of FIG. 1.

FIG. 28 is an illustration of an example advertisement bid management interface of an advertisement control system according to an embodiment of this disclosure.

FIG. 29 is a flowchart showing a method of operating advertisement control system according to this disclosure.

FIG. 30 is a flowchart showing another method of operating an advertisement control system according to this disclosure.

FIG. 31 is a flowchart showing another method of operating an advertisement control system according to this disclosure.

FIG. 32-33 show a physical signage system according to this disclosure.

FIG. 34 shows and advertising scenario overhead view layout according to an embodiment of this disclosure.

FIG. 35 shows an advertising system according to an embodiment of this disclosure.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

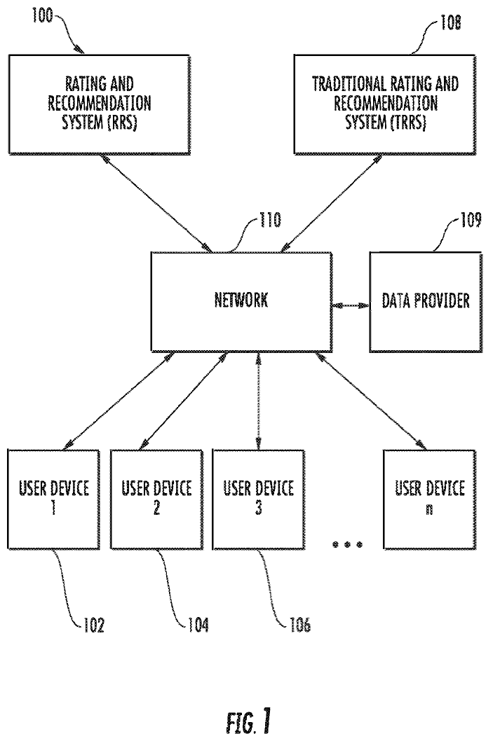

Referring to FIG. 1 in the drawings, a rating and recommendation system (RRS) 100 according to the present disclosure is shown. In some embodiments, the RRS 100 is generally comprises a computer system in bidirectional communication with one or more user devices 102, 104, 106, a traditional rating and recommendation system (TRRS) 108, and/or a data provider 109 via a network 110, such as the internet. Most generally, the RRS is configured to receive information from one or more users via the user devices 102, 104, 106 regarding user preferences and to deliver and/or display rating and/or recommendation information to users in a manner customized as a function of the user preferences received from the users. In some embodiments, the TRRS 108 can comprise a rating and recommendation system substantially similar to those of Yelp and/or other commonly known internet based systems. In some embodiments, the data provider 109 can comprise a subscription based database of merchant information, such as, but not limited to, a directory of restaurants and related information. In some cases, the related information can comprise restaurant location, hours of operation, listing of menu items, categories of cuisine, contact information, service types (i.e., whether fast food, food truck, walk-up service, etc.), and/or any other suitable information. In some embodiments, the data provider 109 can receive queries from the RRS 100 and return information that matches the query. In some cases where the information relates to restaurants, the data provider 109 may limit the number of restaurants and related information returned in response to a query to about 500 results. In some cases, the related information can comprise multiple indications of cuisine types for a single restaurant. In other words, a single restaurant can be associated with multiple cuisines.

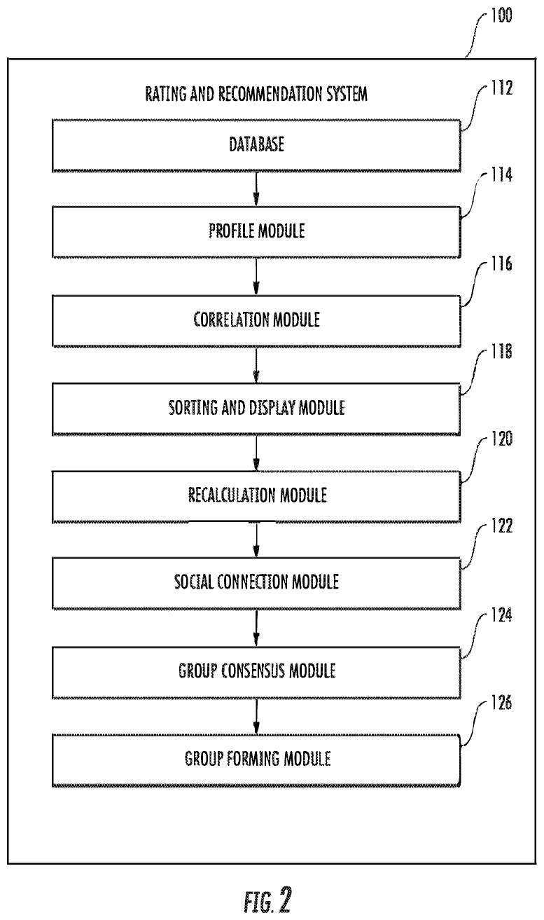

Referring now to FIG. 2 in the drawings, the RRS 100 is shown in greater detail. In some embodiments, the RRS comprises a database 112, a profile module 114, a correlation module 116, a sorting and display module 118, a recalculation module 120, a social connection module 122, a group consensus module 124, and a group forming module 126. The database 112 can comprise one or more relational and/or nonrelational databases and can be configured to receive and store user preference information regarding merchants, goods, service providers, entertainment venues, and the like. The profile module 114 can be operated to solicit user preference information that, in some embodiments, can be stored in the database 112. In some embodiments, user preference information that is specific to a particular user is referred to as a preference profile. In some embodiments, the profile module 114 can be operated to solicit and store the preference profiles in the database 112.

When provided with two preference profiles, the correlation module 116 can be operated to compare two preferences profiles and determine a degree of similarity between the compared preference profiles. The correlation module 116 can be operated to generate a correlation value between compared preference profiles. In some embodiments, a correlation value can be represented as a numerical value where higher numerical values indicate higher similarity between the compared preference profiles. The sorting and display module 118 can be operated to selectively order, sort, and/or display ratings and/or recommendations as a function of the correlation value. Similarly, the recalculation module 120 can be operated to change, augment, and/or otherwise revise a rating value as a function of the correlation value.

Further, the social connection module 122 can be operated to facilitate interaction between and/or utilization of users as a function of the correlation value associated with the users. The group consensus module 124 can be operated to synthesize and/or otherwise generate a group preference profile. The group consensus module 124 can further be operated to employ one or more of the correlation module 116, sorting and display module 118, and/or the recalculation module 120 in a manner substantially similar to that described above, but utilizing the group preference profile in place of an individual user's preference profile. In some cases, the group forming module 126 can be operated to utilize preference profiles to facilitate generation of a list of users that would likely enjoy a particular preselected group related activity or purchase.

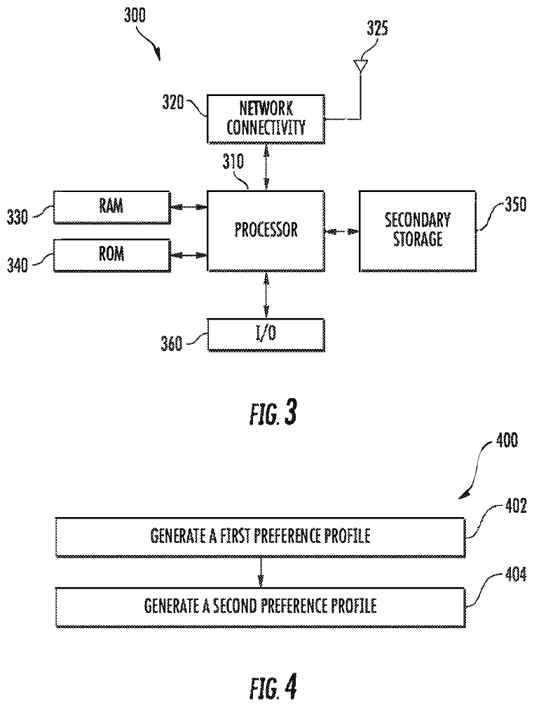

FIG. 3 illustrates a typical, general-purpose processor (e.g., electronic controller or computer) system 300 that includes a processing component 310 suitable for implementing one or more embodiments disclosed herein. In particular, the RRS 100 and/or one or more of the above-described modules of the RRS 100 may comprise one or more systems 300. In addition to the processor 310 (which may be referred to as a central processor unit or CPU), the system 300 might include network connectivity devices 320, random access memory (RAM) 330, read only memory (ROM) 340, secondary storage 350, and input/output (I/O) devices 360. In some cases, some of these components may not be present or may be combined in various combinations with one another or with other components not shown. These components might be located in a single physical entity or in more than one physical entity. Any actions described herein as being taken by the processor 310 might be taken by the processor 310 alone or by the processor 310 in conjunction with one or more components shown or not shown in the drawing. It will be appreciated that the data described herein can be stored in memory and/or in one or more databases.

The processor 310 executes instructions, codes, computer programs, or scripts that it might access from the network connectivity devices 320, RAM 330, ROM 340, or secondary storage 350 (which might include various disk-based systems such as hard disk, floppy disk, optical disk, or other drive). While only one processor 310 is shown, multiple processors may be present. Thus, while instructions may be discussed as being executed by a processor, the instructions may be executed simultaneously, serially, or otherwise by one or multiple processors. The processor 310 may be implemented as one or more CPU chips.

The network connectivity devices 320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 320 may enable the processor 310 to communicate with the Internet or one or more telecommunications networks or other networks from which the processor 310 might receive information or to which the processor 310 might output information.

The network connectivity devices 320 might also include one or more transceiver components 325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 325 might include separate receiving and transmitting units or a single transceiver. Information transmitted or received by the transceiver 325 may include data that has been processed by the processor 310 or instructions that are to be executed by processor 310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 330 might be used to store volatile data and perhaps to store instructions that are executed by the processor 310. The ROM 340 is a non-volatile memory device that typically has a smaller memory capacity than the memory capacity of the secondary storage 350. ROM 340 might be used to store instructions and perhaps data that are read during execution of the instructions. Access to both RAM 330 and ROM 340 is typically faster than to secondary storage 350. The secondary storage 350 is typically comprised of one or more disk drives or tape drives and might be used for non-volatile storage of data or as an over-flow data storage device if RAM 330 is not large enough to hold all working data. Secondary storage 350 may be used to store programs or instructions that are loaded into RAM 330 when such programs are selected for execution or information is needed.

The I/O devices 360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 325 might be considered to be a component of the I/O devices 360 instead of or in addition to being a component of the network connectivity devices 320. Some or all of the I/O devices 360 may be substantially similar to various components disclosed herein.

Most generally, the RRS 100 can be implemented by connecting the RRS 100 with multiple users that may utilize user devices such as 102, 104, 106. The user devices can comprise smart phones, desktop computers, tablet computers, and/or any other suitable device. The RRS 100 can be implemented at least partially via a network 110 and/or utilizing internet websites, software application portals and/or stores, and/or any other suitable system for collecting, disseminating, and/or displaying RRS 100 related information. In some embodiments, the RRS 100 related information comprises dynamic data and some of the dynamic data may comprise user information such as user preference information. The RRS 100 can be utilized for a variety of purposes. While the examples below focus on utilization of the RRS 100 in the context of assisting in decision making based around dining out, restaurant selection, food choices, and other foodstuff related activity, the RRS 100 can similarly be employed to assist with choices of entertainment events, such as, but not limited to, genre of music, video, and/or film, choice of entertainment venue, and the like. Other applications of the RRS 100 include, but are not limited to, automotive, vacation destinations, hotels, books, beer, wine, and/or recipes. The RRS 100 can provide a user with improved intelligence regarding almost any user reviewed criteria and the criteria can comprise a plurality of subcriteria. For example, when utilizing the RRS 100 to assist with dining out decisions, the matter may comprise any of food type, food cost, location and/or distance, amenities, availability of live music, quality of service, quality of food, quantity of food, wait time, hours of operation, ambiance, and/or any other manner in which a user can conceive to base a review of a particular food, restaurant, or dining out related choice. For the examples below, the primary criteria utilized is the type of food, such as Italian cuisine, American cuisine, Indian cuisine, etc. With the most general functionality of the RRS 100 explained above, examples of operation of each of the modules 114, 116, 118, 120, 122, 124, and 126 are detailed below.

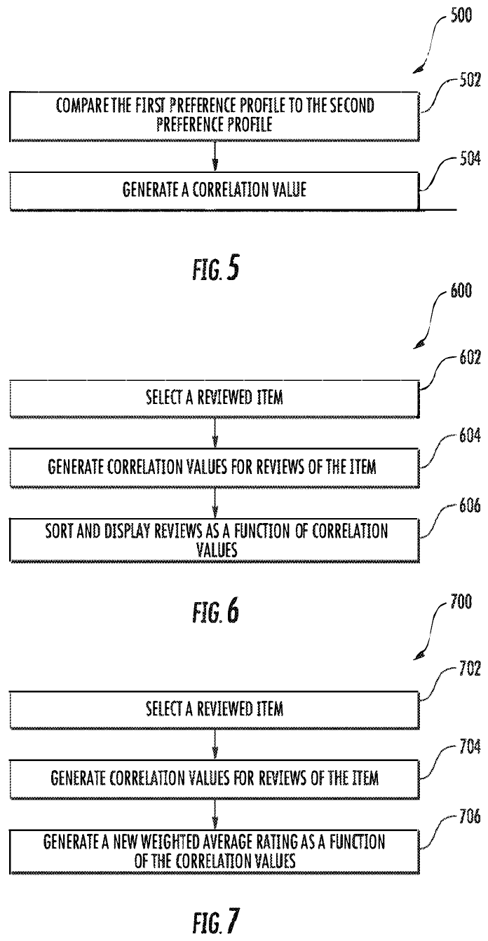

Referring now to FIG. 4 in the drawings, a flowchart of a method 400 of operating the profile module 114 of RRS 100 is shown. Method 400 can begin when the profile module 114 receives information for and generates a first preference profile. The generation of the first preference profile can be followed by the receipt of a first restaurant review from a first user who may utilize a user device, such as user device 102, to provide the information to the RRS 100. The first preference profile comprises a variety of metrics regarding the first user's preferences. For example, the RRS 100 may require the first user to provide information regarding the degree to which the first user likes or dislikes a particular type of food or cuisine. In some embodiments, users may be required to utilize virtual sliders to indicate on a scale of −5 (indicating extreme dislike) to +5 (indicating extreme liking) regarding any of the above-mentioned dining out decision related criteria. The method 400 continues at block 404 when the profile module 114 receives information for and generates a second preference profile based on substantially the same questions as the first profile and in substantially the same manner.

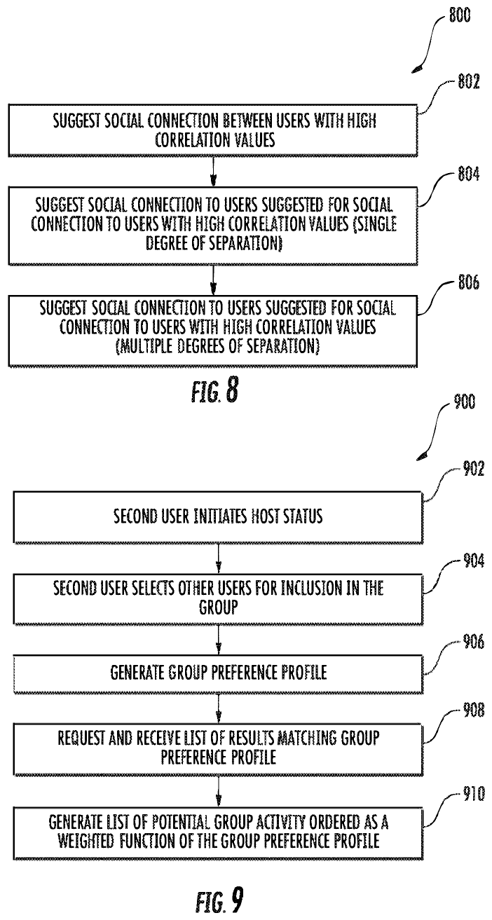

Referring now to FIG. 5 in the drawings, a flowchart of a method 500 of operating the correlation module 116 of RRS 100 is shown. In this embodiment, method 500 begins at block 502 where the correlation module 116 compares the first preference profile to the second preference profile. The method continues at block 504 where the correlation module 116 generates a correlation value between the first preference profile and the second preference profile. In some embodiments, the correlation value can be calculated around a base value of 100 to simulate a base human intelligence quota (IQ). In some embodiments, the correlation value may begin at a value of 100 and be increased when differences between first preference profile values for a criteria are very similar to second preference profile values for the same criteria. Because the differences are small, a positive number can be attributed to the beneficial nature of the users likes being similar and that positive number can be added to the base value of 100. However, where differences between first preference profile values and second preference profile values for a same criteria are medium or large, negative numbers can be attributed to the dissonance between the users likes and dislikes and the negative numbers can be subtracted from the base value of 100. In some embodiments, the correlation value is the base value of 100 plus the positive numbers attributed due to similarities minus the numbers attributed to dissimilarities.

In other words, if a first preference profile closely aligns with a second preference profile, a number greater than 100 would be the correlation value while if a first preference profile is quite different from the second preference profile, a number lower than 100 would be the correlation value. In some cases, the RRS 100 can display the correlation value to a second user associated with the second preference profile so that the second user can determine the level of usefulness a review by the first user associated with the first preference profile may be. Accordingly, a user may discount the review or opinion of the other user when the correlation value between the two users is significantly less than 100. Similarly, when the correlation value between the two users is significantly higher than 100, a user may then know to pay special attention and/or more heavily rely on the review or opinion of another user.

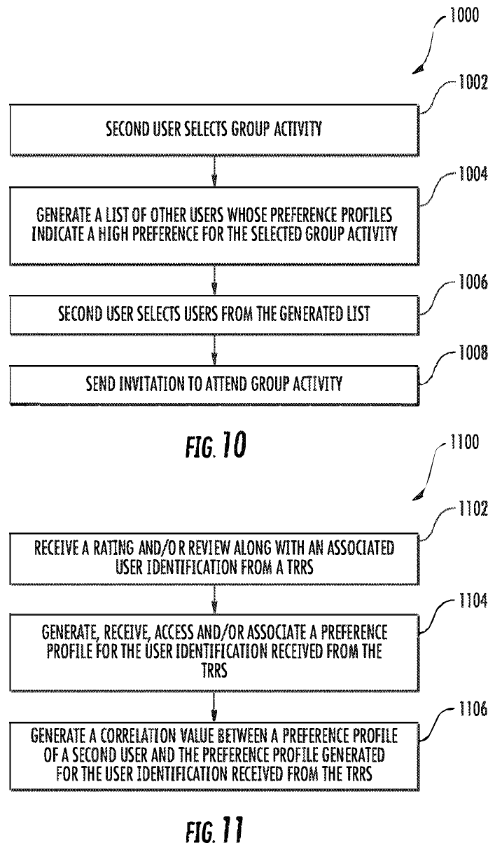

Referring now to FIG. 6 in the drawings, a flowchart of a method of operating the sorting and display module 118 of RRS 100 is shown. In this embodiment, method 600 begins at block 602 when a user such as the second user associated with the second preference profile discussed above with regard to FIGS. 4-5, navigates a web browser to select a particular reviewed item for investigation. Continuing with the previous restaurant example, the second user associated with the second preference profile can select a restaurant that the first user and other users have already reviewed and/or rated. As discussed above, reviews by users who have a low correlation value relative to the second user are presumably less useful to the second user than reviews by users who have a higher correlation value relative to the second user. Accordingly, method 600 continues at block 604 by calculating correlation values between the second user and the users who provided the reviews of the previously selected restaurant. After the correlation values are calculated, the method 600 proceeds to block 606 where the sorting and display module 118 sorts the reviews as a function of the correlation values, such as by locating reviews associated with higher correlation values higher or more immediately viewable, and then facilitating the display of the sorted list by serving the information to the user device or by displaying or otherwise presenting the sorted results.

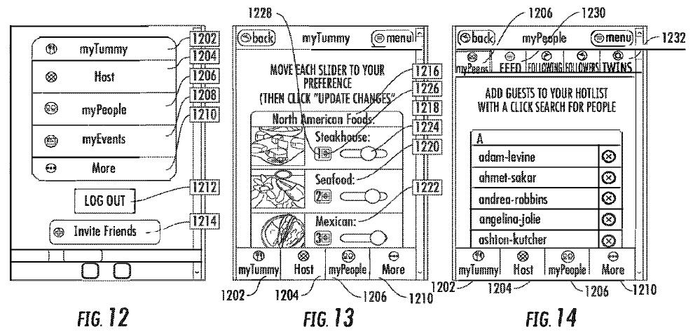

Referring now to FIG. 7 in the drawings, a flowchart of a method 700 of operating the recalculation module 120 of RRS 100 is shown. In this embodiment, method 700 begins at block 702 when a user such as the second user associated with the second preference profile discussed above with regard to FIGS. 4-6, navigates a web browser to select a particular reviewed item for investigation. Continuing with the previous restaurant example, the second user associated with the second preference profile can select a restaurant that the first user and other users have already reviewed and/or rated. As discussed above, reviews and/or ratings, such as but not limited to so-called star ratings, by users who have a low correlation value relative to the second user are presumably less useful to the second user than ratings and/or reviews by users who have a higher correlation value relative to the second user. Accordingly, method 700 continues at block 704 by calculating correlation values between the second user and the users who provided the rating, such as a star rating, of the previously selected restaurant. After the correlation values are calculated, the method 700 proceeds to block 706 where the recalculation module 120 generates a new weighted average star rating value for the selected restaurant. In this manner, the average rating or star rating for the restaurant can be corrected to more closely reflect a score that the second user may potentially be expected to give the restaurant. In some embodiments, high, medium, and low weightings (weight_H, weight_M, weight_L) can be assigned to ratings associated with highly, medium, and lowly correlated values relative to the second user. Next the recalculation module 120 can count the number of high, medium, and low correlated values (num_H, num_M, num_L). Next, the recalculation module 120 can multiply each star rating value by its associated weighting and add the resulting values together. Finally, the sum of the added values can be divided by (weight_H*num_H)+(weight_M*num_M)+(weight_L*num_L) to obtain the newly calculated average rating that is customized for the second user.

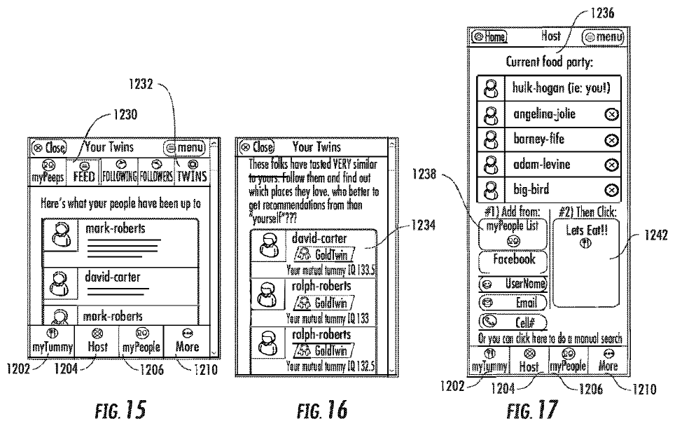

Referring now to FIG. 8 in the drawings, a flowchart of a method 800 of operating the social connection module 122 of RRS 100 is shown. The method 800 may begin at block 802 by the social connection module 122 suggesting a social connection, such as addition of a user to a list of highly correlated users, between users who are discovered to have high correlation values relative to the second user as a function of performing another method disclosed herein. In some embodiments, more social connections and/or a larger list of highly correlated users can be obtained at block 804 by checking the social lists of already listed highly correlated users for additional highly correlated users. In some cases, the RRS 100 and/or the social connection module 122 may employ the use of correlation module 116 to achieve the correlation evaluation. In some cases, after further populating the list at block 804, block 804 may be repeated to check the new listed users for additional highly correlated users. In some cases, where repetition of block 804 does not generate a desired number of users for a correlation list, the social connection module 122 may at block 806 evaluate users for potential inclusion even if the users are two or greater degrees separated from the second user. Finally, the method 800 can include randomly searching users for high correlation values relative to the second user.

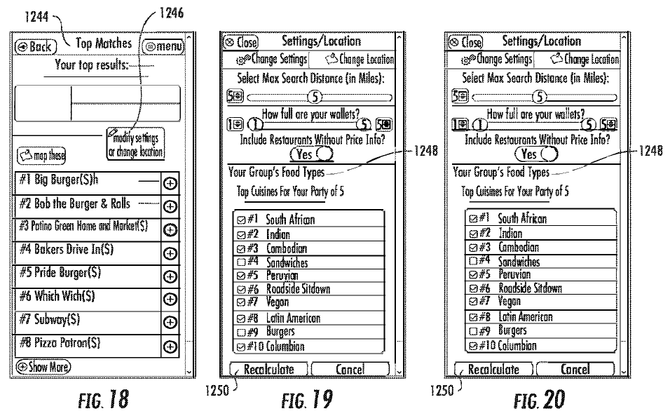

Referring now to FIG. 9 in the drawings, a flowchart of a method 900 of operating the group consensus module 124 of RRS 100 is shown. The method 900 may begin at block 902 when a user such as the second user of the previous examples decides to host or initiate a group activity. The method 900 continues at block 904 where the second user selects other users for inclusion in the group. The method 900 continues at block 906 where the group consensus module 124 combines user preference profile information, in some embodiments by adding together the raw preference profile values entered by users. The combination of the preference profile information can be referred to generally as a group preference profile. Next, at block 908, the method 900 is configured to request and receive a list of results, such as a list of restaurants from a data provider 109, that align with the group preference profile. In some cases, the received results may comprise a large number of results, such as up to about 500 restaurants. In some cases, the module 124 may select a subset of the results, such as about 100 restaurants, as a weighted function of the group preference profile so that restaurants with extremely liked cuisines are more likely to be included in the subset of the results as compared to restaurants with disliked or lesser liked cuisines.

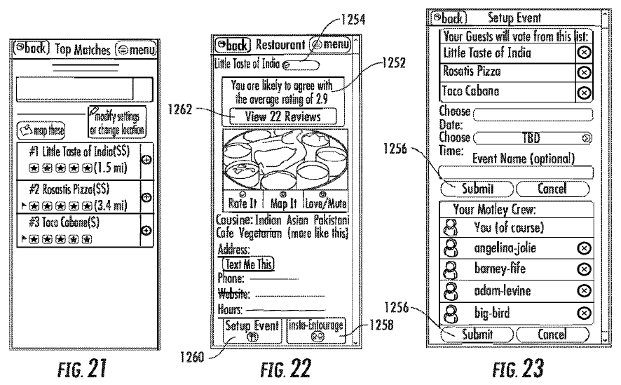

Referring now to FIG. 10 in the drawings, a flowchart of a method of operating the group forming module 126 of RRS 100 is shown. The method 1000 may begin at block 1002 when a user such as the second user of the previous examples decides to host or initiate a group activity by selecting a group activity. In some embodiments, the selecting a group activity may comprise selecting a restaurant to visit. The method may continue by the module 126 generating a list of other users whose preference profiles indicate a relatively higher preference for the selected group activity. In some cases, the selected group activity may comprise visiting a particular restaurant that offers cuisines closely aligned with the users' preference profiles. In some cases, the list of users previously generated at block 1004 includes only users likely to enjoy the cuisine of the previously selected group activity or restaurant. Next at block 1006, the second user can select some or all of the users who are included in the list generated at block 1004. Finally at block 1008, the second user can cause the module 126 to send invitations to attend the group activity to the users selected at block 1006.

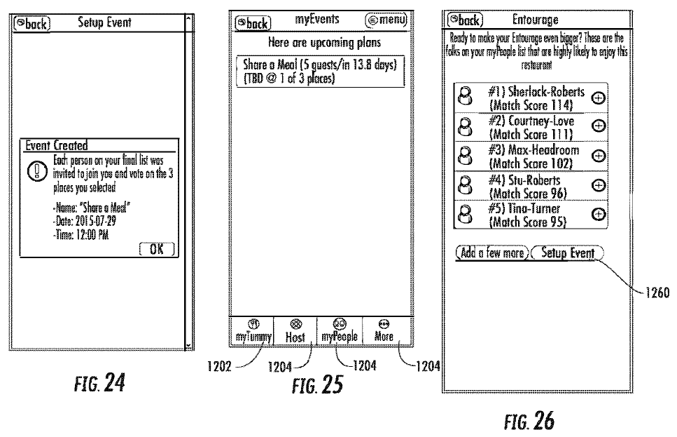

Referring now to FIG. 11 in the drawings, a flowchart of a method of operating the RRS 100 in cooperation with a TRRS 108 is shown. The method 1100 may begin at block 1102 the RRS 100 receives a rating and/or review along with an associated identified user identification from a TRRS 108. In some cases, the rating and/or review may be a restaurant star rating and the user identification may comprise a user's name and/or a login name for the TRRS 108. The method 1100 may continue at block 1104 where the RRS 100 generates, receives, accesses, and/or associates a preference profile for the TRRS user identified in the previous step. Next, at block 1106, the RRS 100 can be operated to generate a correlation value between a preference profile of a user such as the second user described above in the previous examples and the TRRS user identified in the previous steps. Accordingly, by utilizing the method 1100, the ratings and/or review content of the TRRS 108 can be made more useful to users of the RRS 100 by determining the above-described correlation values and thereafter indicating to users of the RRS 100 whether the ratings and/or reviews of the TRRS 108 are likely to be accurate or useful to them as a function of their own preference profiles.

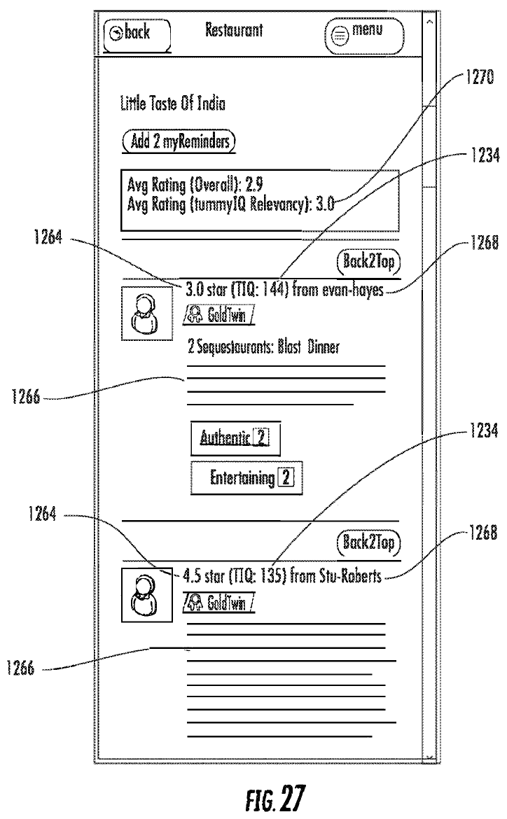

Referring now to FIGS. 12-28, embodiments of user interfaces of the RRS 100 are shown. FIG. 12 shows a home interface comprising the following virtual buttons: myTummy button 1202, Host button 1204, myPeople button 1206, myEvents button 1208, More button 1210, Log Out button 1212, and Invite Friends button 1214.

In some embodiments, pressing the myTummy button 1202 will display a user interface as shown in FIG. 13 comprising a list of preferences groups, such as the North American foods group 1216 and subgroups such as Steakhouse 1218, Seafood 1220, and Mexican 1222. Each subgroup can be associated with a slider 1224 and/or up/down arrow value incrementer 1226 configured to allow a user to input a preference value 1228. The groups and subgroups can comprise any type of potential user preference, but in this embodiment, the users preferences are related to restaurants and dining out. After a user has utilized the sliders 1224 and/or the value incrementers 1226 to generate their desired preference values 1228, the user may utilize an Update Changes virtual button to save the data and information that forms their preference profile.

In some embodiments, pressing the myPeople or myPeeps button 1206 will display a user interface as shown in FIG. 14 comprising a list of other users who are considered connected or socially connected to the user. The RRS 100 can offer functionality substantially similar to Facebook type functionality regarding following viewing activity feeds of other users. In some embodiments, pressing the Feed button 1230 can display a user interface as shown in FIG. 15. In some embodiments, the RRS 100 further comprises a Twins button 1232. In some cases, pressing the Twins button 1232 can, as shown in FIG. 16, display a user list of other users that have preference profiles relative to the user that result in high correlation values, such as correlation value 1234. While the correlation value is shown as a numerical value, the correlation values of RRS 100 can comprise any other representation and/or indication of a relative level of correlation between the preference profile of the user and another user. In some embodiments, the representation and/or indication may comprise a color, color scheme, a visible pattern, an icon, and/or the like.

In some embodiments, pressing the Host button 1204 can display a user interface such as that shown in FIG. 17. The user interface can display a list of users that are currently included for consideration in selection of a restaurant for the group to visit. The user can select the myPeople list button 1238 to be shown a list of their current social connections or connected users and be allowed to add any of the users of that list to the current food party list 1236. Alternatively, the user can select the Facebook button 1240 to be shown a list of their current Facebook friends or otherwise Facebook based connected users and be allowed to add any of the users of that list to the current food party list 1236. Since each user in the current food party list 1236 has their own preference profile, in some embodiments, the preference profiles of each of the users who may dine together are taken into consideration. In some embodiments, the preference profiles of the users in the current food party list 1236 can be combined, in some embodiment by summing the values, to create a group preference profile using preference values. Next, the RRS 100 can query the data provider 109 for a large list of restaurants that include cuisines most favored by the users of the current food party list 1236. Since the restaurant information returned to the RRS 100 may comprise a large number of restaurants and since each restaurant may be associated with a plurality of cuisines and/or other categories, the RRS 100 can determine a demand level for each of the restaurants by scoring the restaurants so that restaurants with the most raw preference profile value overlap and/or correlation with the group preference profile are selected to populate a smaller list of restaurants ordered based on the group preference as a whole instead of based on a single user of the group.

As a simplified example of how the smaller list of restaurants may be ordered, consider the following scenario where a list of restaurants is returned to RRS 100 by data provider 109 as comprising Restaurants 1, 2, and 3 where Restaurant 1 serves 50% American cuisine, 50% Italian cuisine, and 0% Indian cuisine, Restaurant 2 serves 0% American cuisine, 50% Italian cuisine, and 50% Indian cuisine, and Restaurant 3 serves 50% American cuisine, 0% Italian cuisine, and 50% Indian cuisine. Further, consider that there is a current food party list that includes Users 1, 2, and 3 where User 1 has indicated preference values of +1 for American cuisine, +4 for Italian cuisine, and −2 for Indian cuisine, User 2 has indicated preference values of +2 for American cuisine, +1 for Italian cuisine, and +5 for Indian cuisine, and User 3 has indicated preference values of −2 for American cuisine, −1 for Italian cuisine, and +3 for Indian cuisine. Collectively, the group preference can be additively determined as +1 for American cuisine, +4 for Italian cuisine, and +6 for Indian cuisine. If the restaurants were to be listed in order of only User 1's preference, User 2's preference, or User 3's preference, the result would differ from the group preference profile based order of (in order of decreasing preference) Restaurant 3, Restaurant 1, Restaurant 2.

After having populated the current food party list 1236 as desired, a user can select the Lets Eat button 1242. After pressing the Lets Eat button 1242, the user may be presented with a user interface as shown in FIG. 18 which displays a Top Matches list 1244 that lists the restaurants in order as a function of the group preference profile as described above. If the user does not like the contents of the Top Matches list 1244, the user can select the Modify Settings or Change Location button 1246. After selecting the button 1246, the RRS 100 can present a user interface as shown in FIG. 19 that comprises a Your Group's Food Types list 1248 comprising a listing of the cuisines and/or other characteristics collectively desired by the group. In some cases, the user can deselect one or more of the food types or other characteristics. FIG. 20 shows an example where a user has deselected both the fourth and ninth ranking cuisines and/or characteristics, namely, sandwiches and burgers. After deselecting the undesired characteristics, the user can select a Recalculate button 1250. After selecting the Recalculate button 1250, the user can be presented, as shown in FIG. 21, with a revised list of restaurants in order of best matching the group preference profile. A user can select a listed restaurant and the RRS 100 can present a view of the restaurant information as shown in FIG. 22. A user is further presented with a correlation indication 1252 which displays or otherwise presents information regarding a degree to which the user may concur with a rating or recommendation (or average rating) of the restaurant as previously made by other users. The user may select the Add 2 Ballot button 1254 to add the displayed restaurant to a ballot for later review and voting by the users of the current food party list 1236. After populating the above-mentioned ballot, the RRS 100 may display a Setup Event interface such as that shown in FIG. 23 where the user may remove restaurants from the ballot, choose a date and time, name the event, and remove users from the group list. After entering the desired information, the user may select a Submit button 1256 and in return be presented with an Event Created notification such as that shown in FIG. 24. The event may be reviewed and/or displayed as shown in FIG. 25 by selecting the myEvents button 1208 of the interface of FIG. 12.

Referring back to FIG. 22, in some embodiments, a view of a restaurant can generally be accompanied by an Insta-Entourage button 1258. A user can select the Insta-Entourage button 1258 to display a user interface such as that shown in FIG. 26. The user interface of FIG. 26 displays a list of users to which the user is connected (i.e. are otherwise included in the user's myPeople list) and whose preference profile indicates a high likelihood of liking the restaurant previously viewed in the interface of FIG. 22. As such, the user can easily generate a list of users who are likely to enjoy dining at the restaurant previously viewed in the user interface of FIG. 22. After the user has generated a desired list of users, the user can select a Setup Event button 1260. After selecting the Setup Event button 1260, the user can be presented with a user interface substantially similar to the user interface of FIG. 23 to allow the user to remove restaurants from a ballot, choose a date and time, name the event, and remove users from the group list. After entering the desired information, the user may select a Submit button 1256 and in return be presented with an Event Created notification such as that shown in FIG. 24.

Referring back to FIG. 22, in some embodiments, a view of a restaurant can generally be accompanied by a View Ratings button 1262. A user can select the View Ratings button 1262 to display a user interface such as that shown in FIG. 27. The user interface of FIG. 27 displays a list of star ratings 1264 and associated reviews 1266 (collectively referred to as feedback) submitted by users 1268. The users 1268 and their associated star ratings 1264 and reviews 1266 are listed in order of descending correlation values 1234. In this way, the a user viewing the user interface of FIG. 27 is presented with the most relevant feedback from other users about the restaurant first with less relevant feedback about the restaurant being provide lower and/or later in the list of feedback. In some embodiments, a correlation relevancy value 1270 can be provided. In some embodiments, the correlation relevancy value 1270 can be provided as an output and/or function of an output of the recalculation module 120.

As used herein, the term “feedback” is intended to mean a rating, review, commentary, and/or any other suitable information about the goods, services, experience, impression, and/or any other suitable metric and/or judgement regarding a merchant, good, event, location, service, product, process, etc. In other words, feedback can be any opinion or fact information generated by a user about a merchant, good, event, location, service, product, process, etc. In some of the examples above, the feedback comprises ratings, star ratings, reviews, and/or commentary about restaurants and/or cuisines. It will be appreciated that the content of the user interfaces disclosed may be generated, presented, calculated, and/or otherwise handled by one or more of the RRS 100 modules and/or more generally by the RRS 100 as a whole.

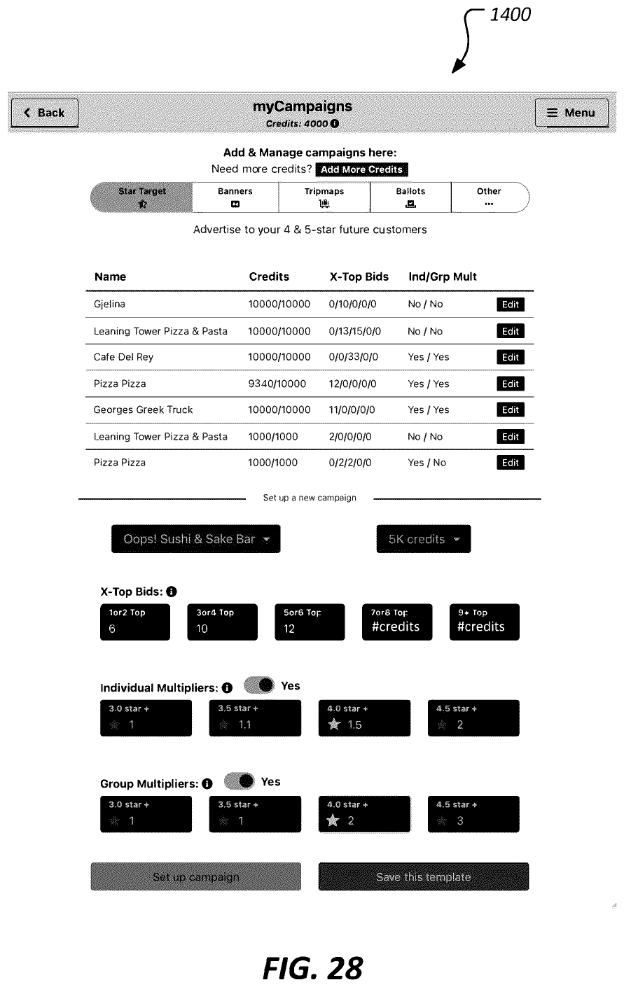

Referring now to FIG. 28 is an illustration of an example advertisement bid management interface of an advertisement control system 1400. While the systems and methods disclosed above are generally directed toward determining preferences and feedback from a user for the purpose of matching a user with things a user would likely provide positive feedback for in the future, system 1400 is configured to utilize previously obtained user preferences and/or feedback of a user to selectively prevent advertising things to user that would likely result in the user issuing negative feedback on. As an example of the system 1400 behavior, system 1400 may comprise substantially similar components and operate substantially similarly as RRS 100 to collect user preferences and/or feedback about restaurants and restaurant experiences and then later utilize the user preferences and/or feedback to avoid presenting an advertisement about a restaurant to the user when it is likely the user would provide undesirable feedback about the restaurant. In this way, system 1400 provides value to the advertiser by avoiding future generation of negative feedback.

Specifically, an advertiser of a restaurant might set up an advertising campaign specifically targeted to users (or small groups of users) that fall into the higher rating predictions for the product/service being advertised. The advertising campaign setup is shown as being bid-based where a manager can set a baseline bid (in either currency or credits) and then apply boosting multiplier factors to higher levels of minimum feedback prediction values. For example, the advertising manager could set a boost multiplier of 1.4× for a prediction at or above 3.5 stars or higher, 2.2× for a prediction at or above 4.0 stars or higher, and 3.4× for a prediction at or above 4.5 stars or higher. The same advertising campaign can could provide an option to pay for hiding impressions (again with currency or credits) for undesirable predicted feedback from a user. For example, the system can allow an advertising manager to pay to prevent presentation of an advertisement of a restaurant to a user predicted to provide negative feedback or ratings for the restaurant below 2.5 stars. This hiding impression threshold bid amount can be the same as a baseline bid but can alternatively be higher or lower. Most generally, the system 1400 allows the advertising manager to avoid risking attracting a user to their product/service that would predictably result in negative feedback. Again, the predictions can be based on previously obtained user preferences, documented word of mouth, and/or through analyzation of feedback obtained by system 1400 or other external systems providing user preferences and/or feedback. System 1400 is provided to enable an advertising manager to avoid advertising to very specific individuals and/or groups and very different from a billboard that merely advertises to every person and/or group within reach.

When the system 1400 is configured in the described bid-based fashion, the bids and any boosting effects can be used as a multiplier to boost organically created match scores created among the pool of other relevant advertisers for the given user based on other factors, in the case of restaurant context, factors such as cuisine types, distance from a chosen location, predicted rating, etc. In such cases, when Restaurant A and Restaurant B both have identical monetary and/or credit bids, when Restaurant A has a higher organic score as compared to Restaurant B, Restaurant A's advertisement position will appear higher than Restaurant B. Further, when boosting multipliers are utilized in a bid-based advertising campaign, the baseline bids can serve as an across the board multiplier effect and the boost multipliers can serve as an additional multipliers in addition to the baseline multiplier effect.

Regardless of exactly how an advertisement of an advertisement bid campaign is configured to provide one advertisement display priority over others, it will be appreciated that an advertising system can selectively display the advertisement that wins the bid process. In some cases, the winning bid can be displayed by physically manipulating signage to change what advertisement content is being displayed.

It will further be appreciated that advertisement system 1400 can be configured to accept bids or costs associated with selectively hiding an advertisement from a user identified by the system as being likely to provide less than a threshold level acceptable feedback on the goods/services being advertised. By way of example only, system 1400 can be configured to hide advertisement of a pizzeria restaurant to a user identified as having expressed dislike for pizza and/or having a history of providing negative ratings or reviews on substantially all pizzarias experienced by the user. Since advertising a pizzeria to the user would predictably result in negative feedback about the pizzeria, the system 1400 can be configured to hide or selectively not initiate display of the advertisement from the user. In some cases, the advertisement to be hidden can be hidden by physically manipulating signage to change what advertisement content is being displayed, obscure the advertisement signage from perception, or operate to not initiate display or presentation of the advertisement.

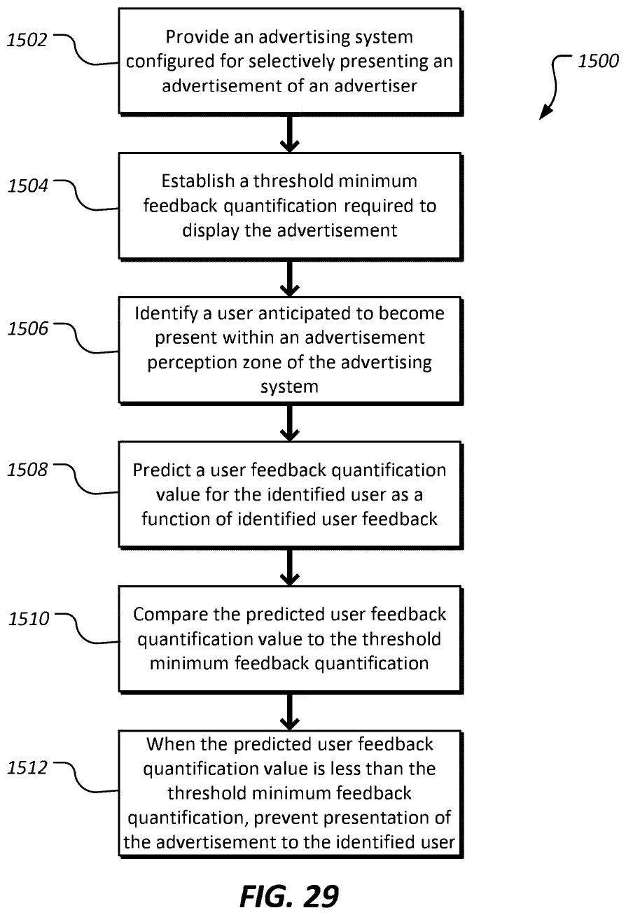

FIG. 29 is a flowchart showing a method 1500 of operating advertisement control system according to this disclosure. At block 1502, an advertising system can be provided and configured for selectively presenting an advertisement of an advertiser. Next at block 1504, a threshold minimum feedback quantification required to display the advertisement can be established. Next at block 1506, the system can identify a user anticipated to become present within an advertisement perception zone of the advertising system. Next at block 1508, the system can predict a user feedback quantification value for the identified user as a function of identified user feedback. Next at block 1510, the system can compare the predicted user feedback quantification value to the threshold minimum feedback quantification. At block 1512, when the predicted user feedback quantification value is less than the threshold minimum feedback quantification, the system can prevent presentation of the advertisement to the identified user. As an example, method 1500 can be instructed that when a user is likely to rate a good or service with a 2.5 star rating or below, the system should not present an advertisement for that good or service to the user. Of course

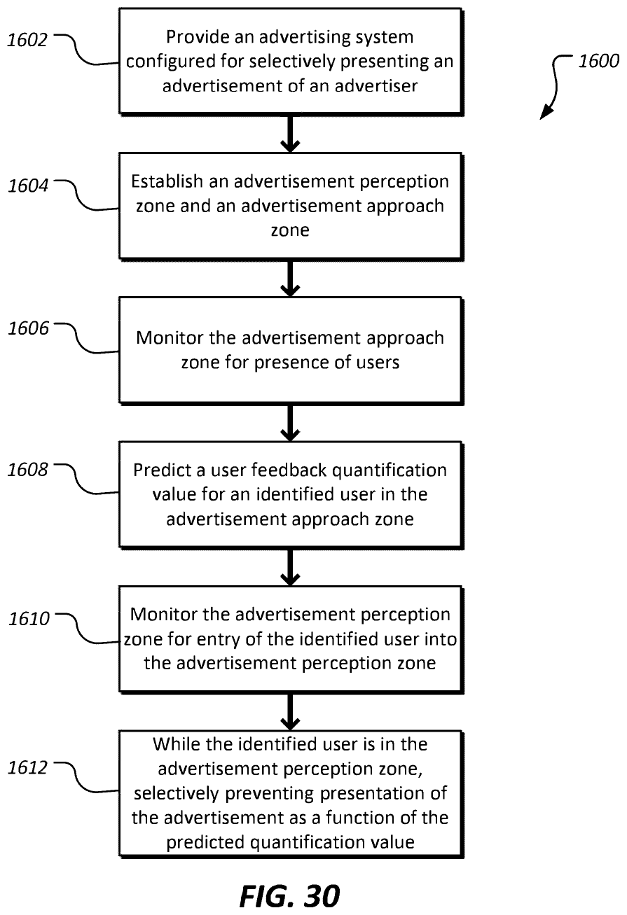

FIG. 30 is a flowchart showing a method 1600 of operating advertisement control system according to this disclosure. At block 1602, the system can be provided and configured for selectively presenting an advertisement of an advertiser. Next at block 1604, the system can establish an advertisement perception zone and an advertisement approach zone. In some cases, the advertisement perception zone is a physical area in which a user can reasonably be expected to perceive an advertisement presented by the system and the advertisement approach zone is a physical area adjacent or near the advertisement perception zone where a user is reasonably expected to be unable to perceive an advertisement presented by the system. At block 1606, the system can monitor the advertisement approach zone for presence of users. At block 1608, the system can predict a user feedback quantification value for an identified user in the advertisement approach zone. At block 1610, the system can monitor the advertisement perception zone for entry of the identified user into the advertisement perception zone. At block 1612, while the identified user is in the advertisement perception zone, the system can selectively prevent presentation of the advertisement as a function of the predicted quantification value. As an example, the system can identify a user in the advertisement approach zone that is likely to rate a good or service associated with an advertisement below a preset threshold level, such as a 2.5 star rating or lower and stop presenting the advertisement when the user is in the advertisement perception zone or, alternatively, operate to purposefully not begin presenting the advertisement.

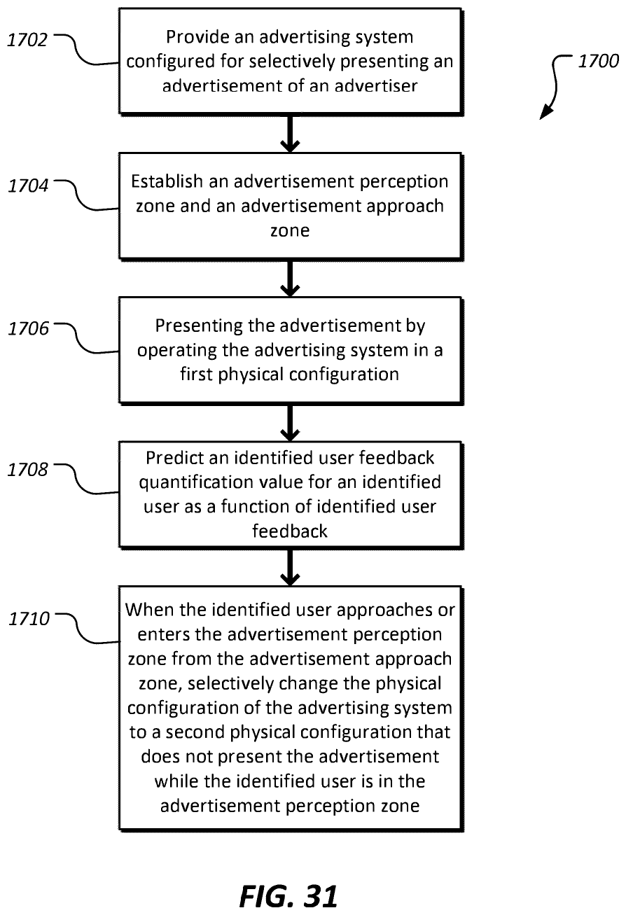

FIG. 31 is a flowchart showing another method 1700 of operating an advertisement control system according to this disclosure. At block 1702, an advertising system configured for selectively presenting an advertisement of an advertiser can be provided. At block 1704, the system can establish an advertisement perception zone and an advertisement approach zone. At block 1706, the system can present the advertisement by operating the advertising system in a first physical configuration. At block 1706, the system can predict an identified user feedback quantification value for an identified user as a function of identified user feedback. At block 1708, when the identified user approaches or enters the advertisement perception zone from the advertisement approach zone, the system can selectively change the physical configuration of the advertising system to a second physical configuration that does not present the advertisement while the identified user is in the advertisement perception zone. As an example, when the system is controlling signage that carries multiple advertisements and is controllable to select which, or which if any, of the multiple advertisements to present, the system can control the signage to physically manipulate the signage to change from a first physical configuration displaying a first advertisement to a second physical configuration that displays a second advertisement or alternatively no advertisement.

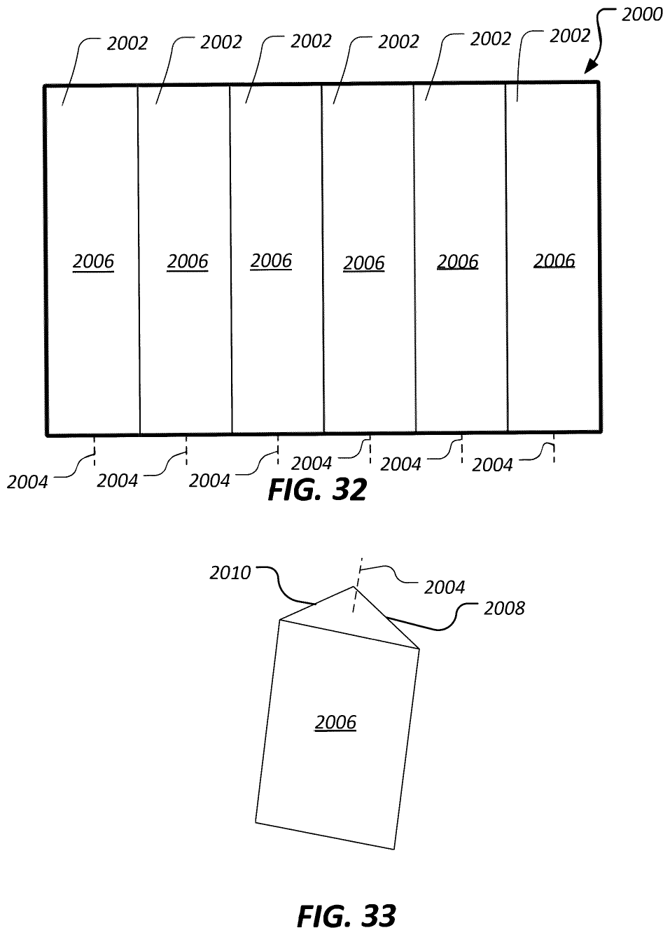

Referring to FIGS. 32 and 33, a physical signage system 2000 is shown. Signage system 2000 comprises multiple elements 2002 that are each rotatable about their own rotation axes 2004. Each element 2002 comprises three sides 2006, 2008, 2010. Elements 2002 can be controlled to simultaneously display sides 2006 to show a first advertisement carried by sides 2006. In some cases, sides 2008 can carry a second advertisement. In some cases, sides 2010 can be blank so that no advertisement is presented when sides 2010 are shown.

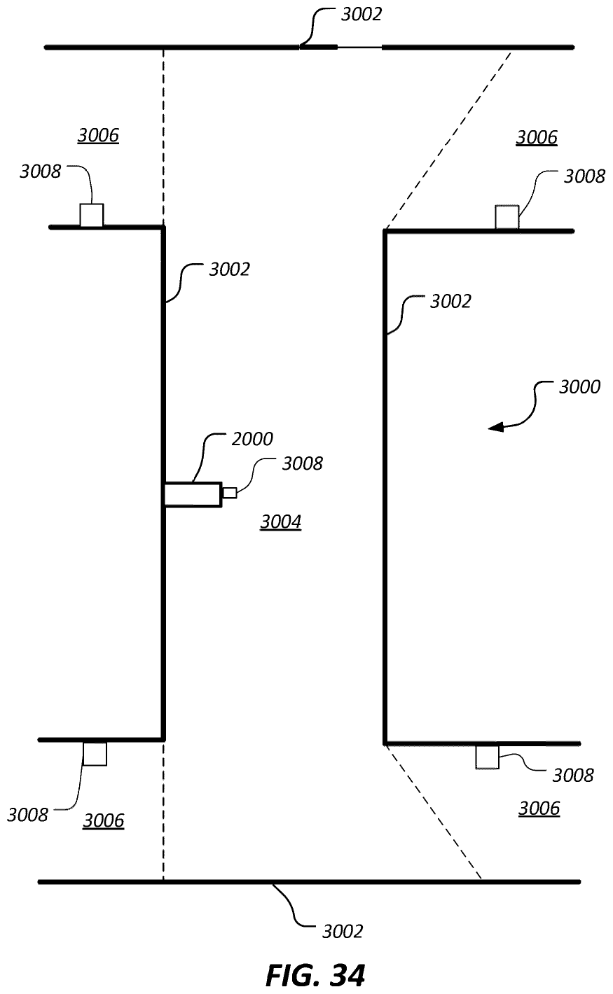

Referring to FIG. 34, an advertising scenario overhead view layout 3000 is shown. Layout 3000 comprises visibility barriers 3002 that can be conceptualized as obstructive shelving, buildings, or walls that are substantially opaque and cannot be seen through sufficiently to perceive an advertisement that is disposed on an opposing side of the barrier 3002. In this embodiment, an advertisement perception zone 3004 is provided that represents an area that, when a user is located in the zone 3004, the user is likely able to perceive, such as visually see, an advertisement presented by a physical signage system 2000. Adjacent to the advertisement perception zone 3004 are advertisement approach zones 3006. Zones 3006, in this embodiment, are somewhat defined by line of sight geometry and when a user is located in zones 3006, the user is presumably unable to perceive, or in this case see, an advertisement presented by the physical signage system 2000. It will be appreciated that sensors 3008 can be used to monitor users present in zones 3004, 3006 and that sensors 3008 and physical signage system 2000 are in communication with one or more of the advertisement control systems disclosed herein. Information gathered by sensors 3008 can be provided to advertisement control systems and or systems such as RRS 100 to conduct the above-described retrieval of user preferences and/or feedback, make future feedback predictions related to the advertisements carried by the physical signage system 2000, and to receive control commands to change a physical configuration of the physical signage system 2000. As such, the physical signage system 2000 can be controlled to avoid presentation of an advertisement to a user that is likely to provide less than desirable feedback about a good or service associated with the advertisement.

It will be appreciated that the physically reconfigurable or physically obscurable signage systems disclosed herein can be utilized with any of the systems, such as, but not limited to, RRS 100 disclosed herein so that an end result of operating a system to solicit, generate, or review feedback of a user is to selectively physically manipulate signage to present or prevent presentation of an advertisement.

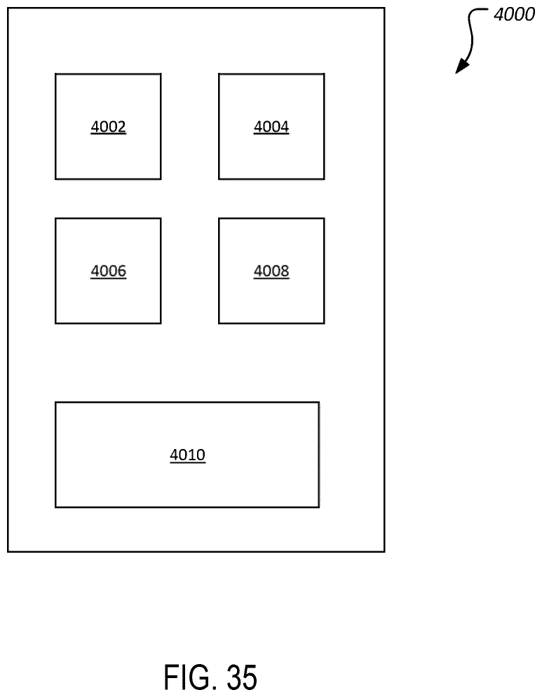

Referring now to FIG. 35, an advertisement control system 4000 is shown. Advertisement control system is configurable to operate and perform some or all of the above-described functionality disclosed and discussed 28-34. System 4000 comprises an input interface component 4002, a receiving component 4004, a retrieving component 4006, a comparison component 4008, and a display component 4010. Components of system 4000 can comprise one or more of the components of embodiments and components disclosed herein, for example, one or more components of FIG. 3, that can be utilized to execute methodologies disclosed herein. It will further be appreciated that, in some embodiments, one or more of the components disclosed herein can be configured to perform a function that cannot reasonably be performed by a human in real time in a manner fast enough to achieve a desired outcome. For example, in some embodiments, the preventing of display of an advertisement to an identified individual cannot be achieved by a human either at all or at a speed fast enough to effectively prevent display of an advertisement to an identified individual.

It will further be appreciated that while physical display components are described above as being physically manipulated between different physical configurations to accomplish desired presentation and hiding of advertisements, in alternative embodiments, the displays being manipulated can comprise phone displays specific to the identified individual, personal computing devices, televisions, billboards, and/or any other electronic or physically adjusted system suitable for displaying or hiding an advertisement. In some embodiments, the selective hiding or presenting of an advertisement can be accomplished in an augmented reality environment, virtual reality environment, mixed reality environment, or the like. For example, in an augmented reality environment, an identified user may be identified in the augmented reality environment so that what is presented to the identified user is different from what is presented to other users with the augmented reality environment. Further, the systems disclosed herein can incorporate visual haptics functionality configured to visually stimulate an identified user differently from other users.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An advertisement system, comprising:
an input interface configured to receive bid-related inputs for a first advertisement;
a receiving component configured to receiving information about an identified user;
a retrieving component configured to retrieve information about the identified user;
a comparison component configured to compare the retrieved information to information about the first advertisement; and
a display component configured to selectively display the first advertisement as a function of the comparison.

2. The advertisement system of claim 1, wherein the retrieving component is configured to retrieve feedback generated by the identified user.

3. The advertisement system of claim 1, wherein the receiving component comprises a sensor configured to receive information about a location of the identified user.

4. The advertisement system of claim 1, wherein the comparison component is further configured to predict a feedback the identified user is likely to generate when exposed to the first advertisement.

5. The advertisement system of claim 4, wherein the comparison component is configured to quantify the predicted feedback.

6. The advertisement system of claim 5, wherein the comparison component is configured to compare the quantified predicted feedback to a threshold feedback value.

7. The advertisement system of claim 6, wherein the comparison component is configured to prevent display of the first advertisement to the identified user when the quantified predicted feedback is lower than the threshold feedback value.

8. The advertisement system of claim 7, wherein the preventing display of the first advertisement comprises physically changing the display from a first physical configuration to a second physical configuration.

9. The advertisement system of claim 6, wherein the comparison component is configured to cause display of the first advertisement to the identified user when the quantified predicted feedback is equal to or greater than the threshold feedback value.

10. The advertisement system of claim 9, wherein the causing display of the first advertisement comprises physically changing the display from a first physical configuration to a second physical configuration.

11. An advertisement system, comprising:
a display component configured to selectively display a first advertisement when the display is in a first physical configuration
a sensing component configured to identify a user within an advertisement approach zone;
a comparison component configured to compare the retrieved information about the user to information about the first advertisement;
wherein, as a function of the comparison between the retrieved information and the information about the user, the display component is changed to a second physical configuration that does not display the first advertisement.

12. The advertisement system of claim 11, wherein the display component is disposed in an advertisement perception zone.

13. The advertisement system of claim 11, wherein the sensing component is a sensor physically disposed in the advertisement approach zone.

14. The advertisement system of claim 11, comprising an advertisement perception zone in which perception of the first advertisement is easier for a user to perceive as compared to the ease with which the first advertisement can be perceived from the advertisement approach zone.

15. The advertisement system of claim 11, wherein the display component comprises rotatable components.

16. The advertisement system of claim 15, wherein the rotatable components comprise at least two sides.

17. The advertisement system of claim 16, wherein a first side carries the first advertisement and a second side carries a second advertisement.

18. The advertisement system of claim 16, wherein a first side carries the first advertisement and a second side carries no advertisement.

19. A system, comprising:
a memory comprising a first preference profile and a second preference profile;
a correlation module configured to determine a correlation value between the first preference profile and the second preference profile; and
a module configured to take an action as a function of the correlation value;
wherein the action is changing a physical configuration of signage from a first physical configuration to a second physical configuration.

20. The system of claim 19, wherein the first physical configuration presents a first advertisement and wherein the second physical configuration presents either a second advertisement or no advertisement.
